(19) United States
(12) Patent Application Publication
(10) Pub. No.: US 2009/0021456 A1
(43) Pub. Date: Jan. 22, 2009

(54) METHOD OF COLOUR IMAGE PROJECTION USING SPATIAL LIGHT MODULATION AND LIGHT SOURCE MODULATION

(75) Inventors: Carsten Deppe, Aachen (DE); Holger Monch, Vaals (NL)

Correspondence Address: PHILIPS INTELLECTUAL PROPERTY & STANDARDS, 3 BURLINGTON WOODS DRIVE, BURLINGTON, MA, 01803, US

(73) Assignee: KONINKLIJKE PHILIPS ELECTRONICS, N.V., Eindhoven (NL)

(21) Appl. No.: 12/280,109

(22) PCT Filed: Feb. 12, 2007
(86) PCT No.: PCT/IB07/50455

§ 371 Date: Aug. 20, 2008

(30) Foreign Application Priority Data
Feb. 22, 2006 (EP) 06110265.3

(51) Int. Cl. G09G 3/32

(52) U.S. Cl. 345/77; 345/78

(57) ABSTRACT

The present invention relates to a method of operating a projection system comprising several solid state light sources (2, 3, 4) of different colour 13, 14, 15) and at least one spatial light modulator (1) having an array of switchable elements. Said array is illuminated by at least one of said light sources (2, 3, 4) for several illumination periods and is addressed such that the light is timely and spatially modulated to project images onto a screen. In the present method said light sources (2, 3, 4) are controlled to emit light modulated in amplitude (15) and/or time (18) during said illumination periods of said array. With the present method an increased greyscale resolution of the projection system can be achieved.

The present invention relates to a method of operating a projection system, the projection system comprising several solid state light sources of different colour and at least one spatial light modulator having an array of switchable elements, wherein said array is illuminated by at least one of said light sources for several illumination periods and is addressed such that the light is timely in spatially modulated to project images onto a screen. The invention also refers to a projection device operated according to the method.

Projection systems with spatial light modulators are frequently used as the basis for display systems. Examples for spatial light modulators are liquid crystal devices (LCD), digital micro mirror devices (DMD) and actuated mirror arrays (AMA). One or several light sources illuminate an array of individual switchable elements of these devices. The array is addressed such that the light is modulated into images that are then projected onto a screen.

Some kinds of spatial light modulators function in a digital fashion, where each individual switchable element is either ON or OFF, where in the ON state the elements transfer light to the screen. These types of modulators typically use pulse width modulation (PWM). In pulse width modulation the intensity of each pixel in the image is assigned a digital value, which is obtained by having the element on the array corresponding to the pixel in the ON state for a time that equals said value. It is therefore possible to display grey scale images by controlling the time for which each switchable element of the device is in a state such that light from the element arrives at the displayed image. Due to the integrating response of the human eye an observer will perceive a corresponding greyscale image from the elements.

In addition to well known 3-panel LCD systems also 1-panel DLP (Digital Light Processing) systems are realized. In one of the known embodiments of such 1-panel systems three or more colour components of a white light source are directed in a sequential manner to the spatial light modulator by using a rotating colour wheel. For each illumination period in which a colour is transmitted, the spatial light modulator is controlled in accordance with the portion this colour component in the image.

Instead of using a white light source and a colour wheel it is also known to use LED light sources of different colours. These LED light sources are then operated sequentially in order to produce a similar sequential colour illumination as with the use of a colour wheel. Such a technique, which is known for example from EP 1 489 854 A2, has a greater efficiency compared to the solution with the colour wheel since no light is blocked during operation.

A general draw back of such a projection system is the small greyscale resolution which can be achieved. This is due to the limited switching times of the switchable elements of the array in spatial light modulators. DLP systems of the next generation achieve switching times of approximately 10 μs. Based on this value the digital resolution in brightness can be calculated. At an image frequency of 60 Hz the projection of three basic colours can be divided into 550 steps resulting in a greyscale resolution of 9 bit. Due to the nonlinear behaviour of the human eye this resolution is not sufficient, in particular because further losses caused by other effects arise.

It is an object of the present invention to provide a method of operating a projection system and a corresponding projection device, which allow the projection of images with an improved greyscale resolution.

This object is achieved with the method and device according to present claims 1 and 10. Advantageous embodiments of the method and device are subject matter of the dependent claims or are described in the subsequent part of the description and examples.

In the proposed method of operating a projection system the array of the at least one spatial light modulator is illuminated by at least one of the light sources for several illumination periods and is addressed such that the light is timely and spatially modulated to project images onto a screen. The method is characterized in that the light sources are controlled to emit light modulated in amplitude and/or time during at least one of the illumination periods of said array. This means that each light source which illuminates the array during a corresponding illumination period is not only switched on and off at the beginning and at the end of the illumination period but is additionally actively modulated in amplitude and/or time during this illumination period. The amplitude is modulated to achieve a change in amplitude between at least two different amplitude values which are greater than zero. With the alternative or additional modulation in time at least one light pulse is generated which has a pulse width shorter than the shortest switching state of the switchable elements, in which the light is directed onto the screen (ON state). The shortest switching state is depending on the addressing of the array and limited by the switching times of the switchable elements. The modulation in amplitude and/or time is typically performed during all illumination periods. Nevertheless it is also possible to perform this modulation only during illumination periods in which a reduced amount of light contributes to the greyscale resolution for the corresponding projection period.

The method can be used to operate a projection system with several spatial light modulators, for example a 3-panel system in which each of the three spatial light modulators is illuminated by a light source of different colour. All light sources are then controlled to emit light modulated in amplitude and/or time during the illumination periods of the arrays of the spatial light modulators. The proposed method can further be used for a projection system with only one spatial light modulator which is illuminated by the several solid state light sources of different colour in a sequential manner (1-panel system). During each period of illuminating the array of switchable elements with one colour the corresponding light source—or light sources in the case of a mixing of colours—is actively modulated in amplitude and/or time.

This additional modulation is possible since modern solid state light sources, like LED's or laser diodes or arrays of such elements, can be switched in very short times compared to the switching times of the switchable elements of the spatial light modulator. In pulsed operation currents larger than the normal current can be used to drive the light sources. A limitation in switching time is mainly set by the limitation in power. LED's, for example, have switching times of far lower than 1 μs. The same applies to the above mentioned laser diodes. Therefore, due to the additional modulation of the solid state light sources the greyscale resolution of the projection system can be increased by appropriately controlling the light emission of the solid state light sources in addition to the modulation of the light by the spatial light modulator.

The several solid state light sources of different colour of the operated projected system are preferably at least three solid state light sources emitting red, green and blue light. Nevertheless it is also possible to use light sources of other basic colours and/or one or several additional white light sources. The number and colours of the light sources depend on the individual application of the projection system. Examples of digital light modulators of the projection system are liquid crystal devices (LCD), in particular ferroelectric LCD devices, and digital micro mirror devices (DMD).

During operation of a 1-panel projection system the spatial light modulator is illuminated by the different colours of the light sources in a sequential manner. To this end the different light sources are operated one after the other for a defined period of time, which is called illumination period in the present application. In order to avoid visible effects the repetition rate of this sequential illumination should be higher than the image frequency of the images to be displayed. Examples of actual systems are sequences >200 Hz, for example 240 Hz at an image frequency of 60 Hz (4× system).

In many applications the switching elements of the whole array of the spatial light modulator are switched at the same time between consecutive addressing periods. In this case it needs some time in order to write the necessary information into the internal memory of the light modulator (charging time). This time can be on the order of for example 100 μs and is lost for light generation. In the present method, the solid state light sources preferably are switched off during this addressing periods in order to save energy.

In one preferred embodiment of the proposed method the light sources are controlled to emit light reduced in amplitude, i.e. intensity, during at least one ON state of said switchable elements. With this amplitude modulation the greyscale resolution of the projection system can be improved by adding one or more new bits, which represent greyscale values smaller than the greyscale value of the former LSB (Least Significant Bit). The amplitude modulation of the solid state light sources can be achieved for example by controlling the operating current of these light sources, in particular in the case of LED's.

In an other advantageous embodiment using a modulation in time during at least one ON state of the switchable elements the light sources are controlled to emit light pulses having a duration shorter than this switching state. By varying the pulse widths of these light pulses the amount of light directed to the screen during an ON state can be controlled in order to enhance the greyscale resolution of the projection system.

Due to the use of solid state light sources the time periods of illuminating the spatial light modulator with one colour, i.e. the illumination periods, can also be adjusted according to the required amount of light and greyscale resolution. Furthermore, for each single colour a dynamical adaptation to the maximum value can be achieved by controlling the duration of the illumination periods (optimal power use, contrast enhancement). In a 1-panel system it is also possible to generate illumination periods of white colour dependent on the saturation rate in the image by illuminating the spatial light modulator during these illumination periods with all light sources (for example red, green and blue) at the same time. In the same manner a mixing colour can be produced dependent on the saturation rate in the image by illumination with several of the light sources at the same time. With this method the reduction of so called colour breakup artefacts in the projected images can be achieved.

When modulating the light sources in time to emit light pulses having a duration shorter than the shortest switching state of the switchable elements, several of the switchable elements are preferably switched at different times, i.e. not at the same time, between consecutive addressing periods of the array. In this case the switching times must be controlled such that the resulting switching states still timely coincide with the light pulses. With this technique the switching of the array can be distributed over the whole period of addressing thereby reducing peaks in the current demand of the chip forming the array.

With the present method the projection system is operated to produce images with higher quality. The reduction of losses in light during dark times allows a higher image brightness. The adjustment of the amount of light results in an improved grey and colour scale and in total produces less annoying artefacts.

The corresponding projection device comprises several solid state light sources of different colour, a control unit and at least one spatial light modulator having an array of switchable elements, wherein said control is designed to operate the projection device, i.e. the light sources and the spatial light modulator(s), according to the proposed method.

In the present description and claims the word “comprising” does not exclude other elements or steps as well as an “a” or “an” does not exclude a plurality. Also any reference signs in the claims shall not be construed as limiting the scope of these claims.

The following exemplary embodiments show examples of the proposed method with reference to the accompanying figures without limiting the scope of the invention as defined in the claims. The figures show:

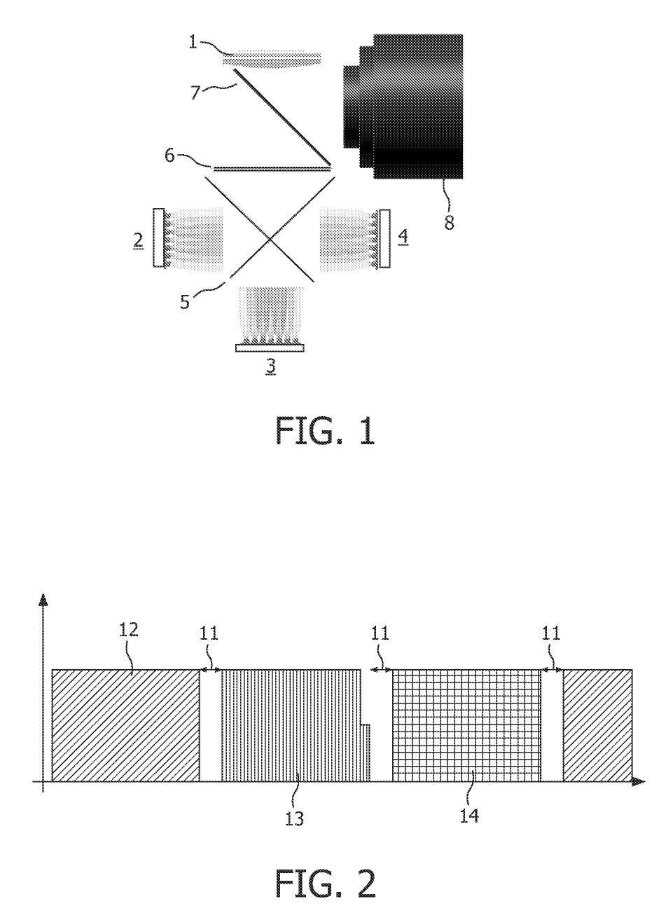

FIG. 1 an example of a projection system which can be operated according to the present invention;

FIG. 2 an example of the sequential illumination of a spatial light modulator with light of different colour;

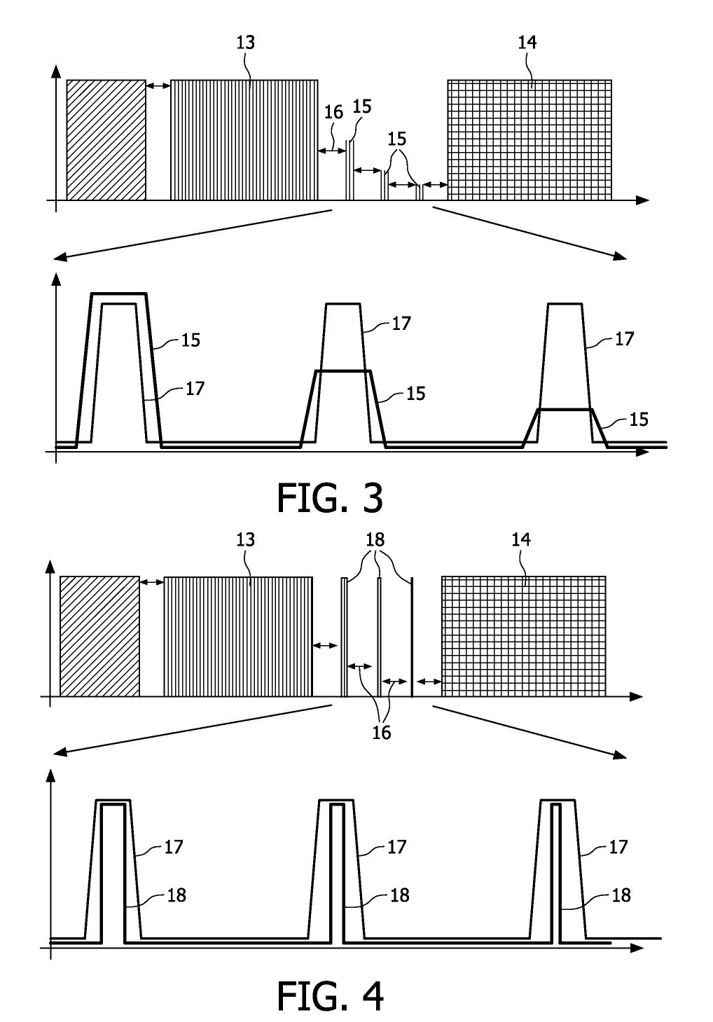

FIG. 3 an example of amplitude modulation by controlling the light sources according the present method;

FIG. 4 an example of time modulation by controlling the light sources according to the method of the present invention; and

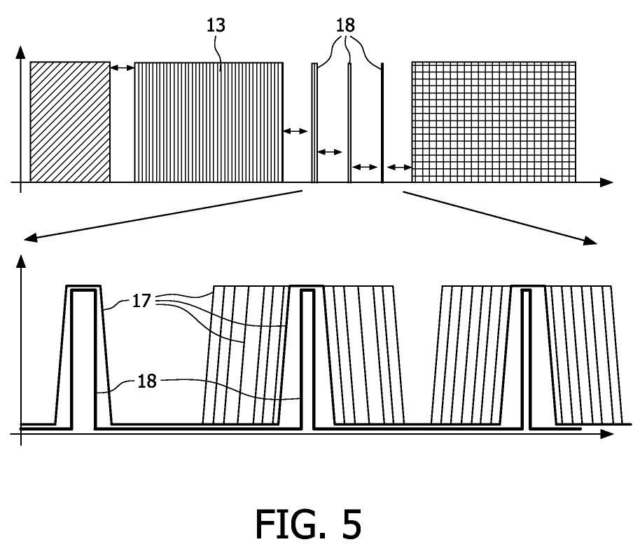

FIG. 5 an example of the present method with distributed switching of the switchable elements.

FIG. 1 shows an example of a projection system which can be operated according to the present method. The projection system comprises a control unit (not shown), a digital light modulator 1 and three LED arrays of red (array 2), green (array 3) and blue colour (array 4). The light of the three LED arrays is directed through dichroic colour combiners 5 and a Fresnel field lens 6 to the array of switchable elements of the digital light modulator 1. The optical system further comprises a wire-grid PBS (Polarising Beam Splitter) 7 and a lens system 8 for directing the modulated light reflected from the digital light modulator 1 to a screen.

The light of the solid state light sources, in the present example LED arrays 2, 3, 4, is directed in a sequential manner to the digital light modulator 1. The switchable elements of the digital light modulator 1 are switched in accordance with the greyscale and colour information to be displayed by means of pulse width modulation during each time period of illumination with one of the three colours. The switchable elements are switched so fast that the human eye can not resolve the switching of the light.

FIG. 2 schematically shows the sequential illumination of the digital light modulator by the different colours. The light source of each colour is operated for a definite illumination period in which the digital light modulator 1 only directs this light in accordance with the image information to the screen. In the example of FIG. 2, first the LED array 2 emitting red light 12 is operated for a definite time period (illumination period). After this illumination period the red light source 2 is switched off. In the following, the green LED array 3 is operated emitting green light 13 for a definite illumination period. After switching off the green LED array 3 the blue LED array 4 is operated emitting blue light 14 for a definite illumination period. This sequential illumination continues with the red LED array 2 being operated after the blue LED array 4 and so on. In order to avoid unnecessary energy dissipation a pause is made between the switching off of one light source and the subsequent operation of another light source. This pause corresponds to the addressing time 11 of the digital light modulator 1 which is necessary to load the new control information for the next switching of the switchable elements.

FIG. 2 shows an amplitude modulation of the light sources during the illumination period with the green light 13 as an example. As can be seen from the figure, the intensity of this green light is reduced at the end of the illumination period by one half, thereby adding a new LSB (Least Significant Bit) to the greyscale resolution achievable with the digital light modulator 1. Such an amplitude modulation can be used in order to further increase the greyscale resolution of the projection system as is demonstrated as an example in FIG. 3.

FIG. 3 shows the modulation of the green LED array 3 to emit green light 13 modulated in amplitude. In a first period of time the green light 13 is emitted with a constant amplitude. After this period the light source is switched off during an addressing time 16 of the digital light modulator 1 and then emits a light pulse 15 with a lower amplitude. This is repeated two times with further reduced amplitudes of the green light emission. The three different amplitudes are shown in the lower part of the figure in which also the time period is shown in which the corresponding switchable elements of the digital light modulator are in an ON state, i.e. reflect the light onto the screen. The duration of the light emission of the green light source is such that it exceeds the duration of the switching state 17 of the switchable element. Due to the amplitude modulation a higher greyscale resolution can be achieved corresponding to lower value bits of the image signal.

FIG. 4 shows an embodiment of the present method in which the pulse width of the light emitted by the light sources 2-4 is modulated. This embodiment is also only schematically explained with reference to the green light 13. In this case after a longer period of constant light emission three pulses 18 are emitted with different pulse width. These pulse widths are shorter than the shortest switching state 17 of the switchable elements as can be seen in the lower portion of the figure. Therefore, the amount of light arriving at the screen can also be reduced with this technique of pulse width modulation of the emitted light in order to increase the greyscale resolution of the projection system.

Since the switching times of the light sources are significantly faster than the switching times of the switchable elements, this technique has the further advantage that the switchable elements of the digital light modulator can be switched at different times and must not be switched at the same time resulting in a high power demand. This is schematically indicated in the embodiment of FIG. 5. This figure shows in the upper part the same modulation as already explained with respect to FIG. 4. In the lower part a possible distribution of switching states 17 of the switchable elements is indicated. The switching of this elements can be distributed over a large period between consecutive addressing periods as far as it is ensured that the modulated light pulse still timely coincides with the resulting switching state. The amount of light reaching the screen in this case only depends on the pulse width of the light pulse and not on the duration of the switching state of the switchable element.

### LIST OF REFERENCE SIGNS

1 Digital light modulator
2 Red LED array
3 Green LED array
4 Blue LED array
5 Dichroic colour combiner
6 Fresnel field lens
7 Wire-grid PBS
8 Lens system
11 Addressing time
12 Red light
13 Green light
14 Blue light
15 Light pulses of different amplitudes
16 Addressing time
17 Switching state (ON) of switchable element
18 Light pulses with different pulse widths

1. A method of operating a projection system, said projection system comprising several solid state light sources of different colour and at least one spatial light modulator having an array of switchable elements, said array being illuminated by at least one of said light sources and addressed such that the light is timely and spatially modulated to project images onto a screen, said modulation being achieved by switching said switchable elements by means of pulse width modulation, wherein at least one of said light sources (2, 3, 4) is controlled to emit light modulated in time, to generate at least one light pulse during at least one switching state of said switchable elements, in which the light is directed onto the screen, said light pulse having a duration shorter than a shortest switching state of said switchable elements.

2. The method according to claim 1, wherein said array is sequentially illuminated by said light sources.

3. The method according to claim 1, wherein said light sources are switched off during addressing periods of said array.

4. The method according to claim 1, wherein said light sources are controlled to emit a reduced amount of light during at least one switching state of said switchable elements, in which the light is directed onto the screen.

5. (canceled)

6. The method according to claim 1, wherein said array of switchable elements is addressed such that between consecutive addressing periods, different switchable elements of said array are switched at different times, wherein the switching times are controlled such that the resulting switching states, in which the light is directed onto the screen, timely coincide with the emission of the light pulses.

7. (canceled)

8. The method according to claim 1, wherein said array is illuminated by the at least one of said light sources for at least two illumination periods, each illumination period being a predetermined time period during which the spatial light modulator is illuminated with and directs light of a particular colour to the screen, and wherein said illumination periods are dynamically adjusted in time duration and/or amplitude for each colour according to a required amount of light and greyscale resolution and/or to a maximum value of the corresponding colour in the image.

9. The method according to claim 8, wherein during at least one of said illumination periods more than one light source is activated to generate a mixed base colour or white light.

10. A projection device comprising
(a) several solid state light sources of different colour
(b) at least one spatial light modulator having an array of switchable elements, the spatial light modulator configured to be illuminated by at least one of said light sources to project images onto a screen and addressed such that the light is timely and spatially modulated, said modulation being achieved by switching said switchable elements by means of pulse width modulation, and
(c) a control unit, for controlling at least one of said light sources to emit light modulated in time to generate at least one light pulse during at least one switching state of said switchable elements, in which the light is directed onto the screen, said light pulse having a duration shorter than a shortest switching state of said switchable elements.
